(19) United States
(12) Patent Application Publication
(10) Pub. No.: US 2013/0283040 A1
(43) Pub. Date: Oct. 24, 2013

(54) METHOD, SYSTEM AND DEVICE FOR BINDING AND OPERATING A SECURE DIGITAL MEMORY CARD

(71) Applicant: Xiaoqiang Tu, Beijing (CN)

(72) Inventor: Xiaoqiang Tu, Beijing (CN)

(73) Assignee: China Mobile Communications Corporation, Beijing (CN)

(21) Appl. No.: 13/825,964

(22) PCT Filed: Sep. 23, 2011
(86) PCT No.: PCT/CN2011/080087

§ 371 Date: Jul. 12, 2013

(30) Foreign Application Priority Data
Sep. 25, 2010 (CN) 201010291297.3

(51) Int. Cl. H04L 29/06

(52) U.S. Cl. CPC H04L 63/0853
USPC 713/155; 726/5

(57) ABSTRACT

A method, system and device for binding and operating a Secure Digital memory card (SD card) include: after an identification number of a SIM card is sent to the SD card, the SD card does not immediately establish the binding relationship with the SIM card; instead, the SD card establishes the corresponding relationship with the SIM card according to an authentication-passed message returned from an SD server, when the SD server determines that the identification number of the SIM card installed in the mobile terminal, which sends an authentication request, is the same as that of the SIM card in the authentication request; and then, while the services in the SD card are operating, the SD card side and the SD server side determine whether to allow the SD card to response to the services according to the binding relationship between the SD card and the SIM card, thus the security of the application of the service data in the SD card is improved.

This application claims priority from Chinese Patent Application No. 201010291297.3 filed with the Chinese Patent Office on Sep. 25, 2010 and entitled “Method, System and Device for Binding and Operating a Secure Digital Memory Card”, which is herein incorporated by reference in its entirety.

### FIELD OF THE INVENTION

The present invention relates to the field of communications, and in particular to a method, system and device for binding a secure digital memory card (SD) and a subscriber identity module (SIM) and a method, system and device for operating the SD card bound with the SIM.

### BACKGROUND OF THE INVENTION

A secure digital memory card (SD card for short hereafter) is a memory device based on a semiconductor flash memory. Along with the continuous development of SD card technologies, compared with a conventional SD card, a new-type SD card used at present has a central processing unit (CPU) and a security chip integrated therein, so that the new-type SD card has service logic processing capability and security service capability. Because the new-type SD card has the advantages of intelligence, security, high capacity, fast transmission, compatibility with the conventional SD card and the like, the new-type SD card is widely used in mobile services such as mobile television, mobile phone remote payment and copyrighted audio and video content storage.

Before the SD card is used, a telecom operator can store service data of services in the SD card and then distribute the SD card to a user. After the user installs the SD card storing the service data into a mobile terminal and operates the service data in the SD card, corresponding mobile services can be opened and used. The mode of issuing the services through the SD card is easy and convenient to implement, saves the time of the user and does not require to replace the SIM card in the mobile terminal, meanwhile, the services and the service data stored in the SD card can be updated through a software client installed in the mobile terminal, thereby facilitating popularization and use of the mobile services, and this method is a current common method for mobile service popularization and use.

The method for bearing the service data in the SD card to allow the user to conveniently open and use the mobile services has above advantages, but the security of the related data of opening and using the mobile services by the user, recorded in the SD card installed in the mobile terminal, is low; and if the mobile terminal with the SD card installed therein is lost, other illegal persons can acquire the data in the SD card after obtaining the SD card, so that the related data of the original legal user stored in the SD card is illegally used.

For example, a user A pays the fee and then obtains a using permission of monthly service provided in the SD card, and various data required when using the monthly service is stored in the SD card. When the user A's mobile phone with the SD card and the SIM card installed therein is lost, the user A can only log off the lost SIM card immediately, but can not instantly log off the lost SD card; and at this time, after a user B picks up the mobile phone, the opened service in the SD card can still be used as long as the SIM card in the mobile phone is replaced. Unless the user A cancels the paid monthly service in a business hall, otherwise, the user B can illegally use the opened service in the SD card all the time so as to cause the problem that the opened service paid by the user A is illegally used by the user B.

In conclusion, when the mobile terminal with the SD card installed therein is lost, the security of the service data of the services, opened and operated by the legal user, stored in the SD card is not ensured, and thus the problem that the user picking up the mobile terminal illegally uses the opened services in the SD card is easily caused.

### SUMMARY OF THE INVENTION

The embodiments of the application provide a method, system and device for binding and operating a secure digital memory card, so as to solve the problem in the prior art that the security of the service data of the services, opened and operated by the legal user, stored in the SD card can not be ensured when the mobile terminal with the SD card installed therein is lost.

A method for binding an SD card and an SIM, comprising:

transmitting an identification number of the SIM, obtained from the SIM, to the SD card;

receiving a serial number returned from the SD card, and transmitting an authentication request carrying the identification number of the SIM and the serial number of the SD card to an SD server, to request the SD server to verify the serial number of the SD card and return an authentication-passed message after determining that an identification number of an SIM, installed in a mobile terminal transmitting the authentication request, is the same as the identification number of the SIM in the authentication request; and

indicating the SD card to store the identification number of the SIM after receiving the authentication-passed message returned from the SD server.

A method for operating an SD card, comprising:

transmitting an authentication request containing an identification number of an SIM and a serial number of the SD card to an SD server, to request the SD server to verify the serial number of the SD card and return an authentication-passed message after determining that an identification number of an SIM, installed in a mobile terminal transmitting the authentication request, is the same as the identification number of the SIM contained in the received authentication request, otherwise, return an authentication failure message; and

transmitting the received authentication-passed message containing the identification number of the SIM to the SD card, to indicate the SD card to respond to services requested to be operated after determining that the personally stored identification number of the SIM is the same as the received identification number of the SIM, otherwise, reject responding to the services requested to be operated; or

transmitting the received authentication failure message to the SD card, to indicate the SD card to reject responding to the services requested to be operated.

A system for binding an SD card and an SIM, comprising the SIM, the SD card, a client and an SD server, wherein,

the client is used for obtaining an identification number of the SIM from the SIM, transmitting the identification number of the SIM to the SD card, receiving a serial number returned from the SD card, transmitting an authentication request carrying the identification number of the SIM and the serial number of the SD card to the SD server and transmitting a received authentication-passed message returned from the SD server to the SD card;

the SD server is used for verifying the serial number of the SD card and returning the authentication-passed message after determining that an identification number of an SIM, installed in a mobile terminal transmitting the authentication request, is the same as the identification number of the SIM in the authentication request; and

the SD card is used for transmitting the personal serial number to the client and storing the identification number of the SIM after receiving the authentication-passed message.

A client for binding an SD card and an SIM, comprising:

an identification number obtaining module, used for obtaining an identification number of the SIM from the SIM and receiving a serial number transmitted from the SD card;

a transmitting module, used for transmitting the identification number of the SIM to the SD card, and transmitting an authentication request carrying the identification number of the SIM and the serial number of the SD card to an SD server to request the SD server to verify the serial number of the SD card and return an authentication-passed message after determining that an identification number of an SIM, installed in a mobile terminal transmitting the authentication request, is the same as the identification number of the SIM in the authentication request; and

a receiving module, used for indicating the SD card to store the identification number of the SIM after receiving the authentication-passed message returned from the SD server.

An SD card, comprising:

a receiving module, used for receiving an identification number of an SIM and an authentication-passed message indicating that the identification number is permitted to be stored; and

a storing module, used for storing the identification number of the SIM after receiving the authentication-passed message.

An SD server, comprising:

a receiving module, used for receiving an authentication request carrying an identification number of an SIM and a serial number of an SD card;

an authentication module, used for verifying the serial number of the SD card and determining whether an identification number of an SIM, installed in a mobile terminal transmitting the authentication request, is the same as the identification number of the SIM in the authentication request or not; and

a transmitting module, used for returning an authentication-passed message to an SD card corresponding to the serial number of the SD card after determining that the identification number of the SIM, installed in the mobile terminal transmitting the authentication request, is the same as the identification number of the SIM in the authentication request.

A system for operating an SD card, comprising a client, the SD card and an SD server, wherein,

the client is used for transmitting an authentication request containing an identification number of an SIM and a serial number of the SD card to the SD server, and transmitting the identification number of the SIM and a received authentication-passed message or authentication failure message to the SD card;

the SD server is used for verifying the serial number of the SD card and returning the authentication-passed message after determining that an identification number of an SIM, installed in a mobile terminal transmitting the authentication request, is the same as the identification number of the SIM contained in the received authentication request, otherwise, returning the authentication failure message; and

the SD card is used for responding to services requested to be operated after receiving the authentication-passed message and determining that the personally stored identification number of the SIM is the same as the received identification number of the SIM; or rejecting responding to the services requested to be operated after determining that the personally stored identification number of the SIM is different from the received identification number of the SIM or receiving the returned authentication failure message.

A client for operating an SD card, comprising:

a transmitting module, used for transmitting an authentication request containing an identification number of an SIM and a serial number of the SD card to an SD server, and transmitting the identification number of the SIM and a received authentication-passed message or authentication failure message to the SD card; and

a receiving module, used for receiving the authentication-passed message or the authentication failure message returned from the SD server.

An SD card, comprising:

a receiving module, used for receiving an identification number of an SIM and an authentication-passed message or an authentication failure message; and

an execution module, used for responding to services requested to be operated if a personally stored identification number of the SIM is the same as the received identification number of the SIM after receiving the identification number of the SIM and the authentication-passed message; or rejecting responding to the services requested to be operated after determining that the personally stored identification number of the SIM is different from the received identification number of the SIM or receiving the returned authentication failure message.

An SD server, comprising:

a receiving module, used for receiving an authentication request containing an identification number of an SIM and a serial number of an SD card; and

a responding module, used for verifying the serial number of the SD card and returning an authentication-passed message after determining that an identification number of an SIM, installed in a mobile terminal transmitting the authentication request, is the same as the identification number of the SIM contained in the received authentication request, otherwise, returning an authentication failure message.

The embodiments of the application have the following beneficial effects:

In the embodiments of the application, after the identification number of the SIM card is transmitted to the SD card, the SD card does not instantly establish the binding relationship with the SIM card; instead, the SD card establishes the correspondence with the SIM card according to the authentication-passed message returned from the SD server after the SD server determines that the identification number of the SIM card, installed in the mobile terminal transmitting the authentication request, is the same as that of the SIM card in the authentication request, and then the SD card side and the SD server side can judge whether to permit the SD card to respond to the services according to the binding relationship between the SD card and the SIM card when the services in the SD card is operated, so that application security of the service data in the SD card is improved.

### BRIEF DESCRIPTION OF THE DRAWINGS

For more clearly illustrating the embodiments of the application or the technical solution in the prior art, the drawings used in the embodiments or the description of the prior art are simply introduced, and obviously, the drawings in the following description are only some embodiments of the application and the ordinary skilled in the art can obtain other drawings according to these drawings on the premise that creative work is not contributed.

FIG. 1 is a schematic diagram of a method for binding an SD card and an SIM card in a first embodiment of the application;

FIG. 2 is a schematic diagram of a method for binding an SD card and an SIM card in a second embodiment of the application;

FIG. 3 is a schematic diagram of a method for operating a service in an SD card in a third embodiment of the application;

FIG. 4 is a schematic diagram of a method for operating a service in an SD card in a fourth embodiment of the application;

FIG. 5 is a schematic diagram of a method for updating service data in an SD card in a fifth embodiment of the application;

FIG. 6 is a schematic diagram of a method for updating service data in an SD card in a sixth embodiment of the application;

FIG. 7 is a structural schematic diagram of a system for binding an SD card and an SIM card in a seventh embodiment of the application;

FIG. 8 is a structural schematic diagram of a client for binding the SD card and the SIM card in the seventh embodiment of the application;

FIG. 9 is a structural schematic diagram of the SD card in the seventh embodiment of the application;

FIG. 10 is a structural schematic diagram of an SD server in the seventh embodiment of the application;

FIG. 11 is a structural schematic diagram of a system for operating an SD card in an eighth embodiment of the application;

FIG. 12 is a structural schematic diagram of a client for operating the SD card in the eighth embodiment of the application;

FIG. 13 is a structural schematic diagram of the SD card in the eighth embodiment of the application;

FIG. 14 is a structural schematic diagram of an SD server in the eighth embodiment of the application.

### DETAILED DESCRIPTION OF THE EMBODIMENTS

For achieving the objects of the application, in the embodiments of the application, before an SD card is used for the first time, the SD card is bound with an SIM card inserted into a legal mobile terminal, and considering that in practical use, an illegal user can easily read the unique identification number of the SIM card from the SIM card installed in the mobile terminal, after picking up the mobile terminal, thus before the SD card is bound, the security of the environment, where the current SD card locates, is required to be authenticated at an SD server side, namely the SD server verifies whether the identification number of the SIM card, installed in the mobile terminal initiating various requests, is the same as the identification number of the SIM card carried in this request, if so, the binding operation of the current SD card is legal and the SD card is permitted to execute the binding operation; otherwise, the SD card is not permitted to execute the binding operation.

After a binding relationship between the SD card and the SIM card is recorded in both the SD card side and the SD server side, when the SD card is operated, the SD card side and the SD server side together judge whether the SIM card in the mobile terminal initiating the request is consistent with the SIM card bound with the SD card, if not so, the current SD card is authenticated to be in an insecure environment and the service requested to be operated is rejected; otherwise, the service requested to be operated is responded to. It is achieved that when the mobile terminal with the SD card and the SIM card installed therein is lost, as long as the lost SIM card is logged off, the user picking up the SD card cannot operate the services in the SD card, so that the operating security of the services in the SD card is improved.

After the binding relationship between the SD card and the SIM card is recorded in both the SD card and the SD server side, in a scene operating the SD, the service data in the SD card can be further updated, and the SD server side recording the legal binding relationship between the SD card and the SIM card can update the service data in the SD card, thereby avoiding an illegal SD server side updating the service data in the SD card. It is achieved that when the mobile terminal with the SD card and the SIM card installed therein is lost, as long as the lost SIM card is logged off, the user picking up the SD card cannot update the service data in the SD card, so that the security of the service data in the SD card is improved.

The embodiments of the application are described in detail in conjunction with the drawings of the description.

The subscriber identity module involved in each embodiment of the application can be an SIM card, a UIM card or a USIM card. For facilitating description, the SIM card is taken as an example for explaining the solution of the application hereafter.

The SD card and the SIM card involved in each embodiment of the application are components installed in a mobile terminal, the serial number of the SD card is information capable of uniquely expressing the SD card, and the identification number of the SIM card is information capable of uniquely expressing the SIM card, such as an international mobile subscriber identification number (IMSI); and after the SIM card is logged off, the IMSI of the SIM card cannot be used, and the IMSIs of two SIM cards (one is logged off, and the other is activated) expressing the same phone number are different. For facilitating description, the identification number of the SIM card is set to be the IMSI of the SIM card hereafter.

The mobile terminal involved in each embodiment of the application comprises but is not limited to devices capable of having the SD card and the SIM card installed therein, for example, a mobile phone and the like.

A group of preset keys are set in the SD card involved in each embodiment of the application, and the keys preset in every two SD cards are different; and in addition, one or more encryption algorithms are set in the SD card, and the encryption algorithms in every two SD cards can be identical or different. The serial number of each SD card and the key and the encryption algorithm set in the SD card are stored in the SD server.

### First Embodiment

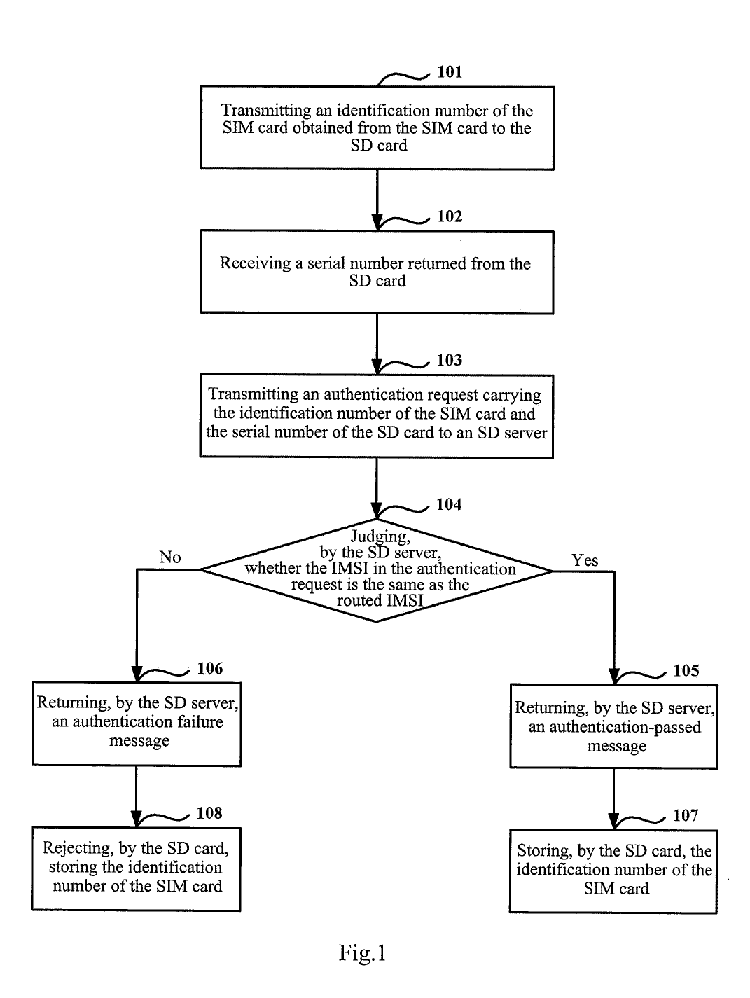

As shown in FIG. 1, which is a schematic diagram of a method for binding an SD card and an SIM card in the first embodiment, the method comprises the following steps:

Step 101: transmitting an identification number of the SIM card obtained from the SIM card to the SD card.

The execution main body of the step can be a client installed in a mobile terminal, the client can be generated in a mode of software, hardware or combination thereof, and the client can be a component integrated in the mobile terminal or in the SD card. Various realization forms of the client are not limited in the application.

The client scans the mobile terminal in real time to determine whether the SD card is installed in the mobile terminal, and after the SD card is installed and activated in the mobile terminal, the client can trigger the SD card to carry out the binding operation in the first embodiment; and in addition, the client can also trigger the SD card to carry out the binding operation after the SD card is installed and activated in the mobile terminal and when a user requires to operate the SD card.

The client can take the starting of the binding operation as a trigger condition and then obtain the IMSI of the SIM card from the SIM card, or can transmit a binding request to the SD card when the binding operation starts, and the SD card requires the client for providing the IMSI of the SIM card after receiving the binding request, and the client takes the requirement of the SD card as a trigger condition and then obtains the IMSI of the SIM card from the SIM card.

In the embodiment, a mark position for binding or unbinding is set in the SD card, and if the SD card has already been bound with the SIM card, the mark position is 1; otherwise, the mark position is 0.

In the step, the client can directly read the IMSI from the SIM card, or can transmit a request for extracting the IMSI to the SIM card and the SIM card transmits the personal IMSI to the client when responding to the request.

Step 102: receiving a serial number returned from the SD card.

The execution main body of the step can also be the client in step 101.

Step 103: transmitting an authentication request carrying the identification number of the SIM card and the serial number of the SD card to an SD server.

The execution main body of the step can also be the client in step 101.

Step 104: verifying, by the SD server, the serial number of the SD card, comparing the identification number of the SIM card carried in the authentication request with an identification number of an SIM card installed in a mobile terminal, and if the comparison result is that they are identical, executing step 105; otherwise, executing step 106.

Because the serial number of each SD card is stored in the SD server, after receiving the serial number of the SD card in the authentication request, the SD server verifies whether the received serial number of the SD card is a stored serial number, if so, passing the authentication and providing authentication service for the SD card; otherwise, rejecting executing subsequent operations.

In step 103, the authentication request can be reported to the SD server in a mode of a short message, a multimedia message, a system message or the like, and no matter in which mode, the authentication request is routed to the SD server through a network, so the SD server can determine the IMSI of the SIM card used in the mobile terminal transmitting the authentication request according to the routing condition of the received authentication request.

In the comparison process of the step, if the comparison result is that they are identical, it indicates that the SIM card simultaneously inserted into the mobile terminal together with the SD card is the one to be bound and the SIM card is authentic. A condition that an illegal user carries the legal IMSI in the authentication request but uses the illegal SIM card to initiate a binding process is avoided, thereby improving the security of the binding process.

Step 105: returning, by the SD server, an authentication-passed message, and skipping to step 107.

Step 106: returning, by the SD server, an authentication failure message, and skipping to step 108.

Step 107: storing, by the SD card, the identification number of the SIM card, and ending.

The authentication-passed message returned from the SD server is firstly transmitted to the client and then forwarded to the SD card by the client, and the SD card trusts the SIM card in the same terminal at present according to the received authentication-passed message.

When the SD card stores the identification number of the SIM card and completes binding with the SIM card, the personal mark position for expressing binding or unbinding is kept at 1.

Step 108: rejecting, by the SD card, storing the identification number of the SIM card, and ending.

The authentication failure message returned from the SD server is firstly transmitted to the client and then forwarded to the SD card by the client, and the SD card does not trust the SIM card in the same terminal at present according to the received authentication failure message.

When the SD card rejects storing the identification number of the SIM card and does not execute binding with the SIM card, the personal mark position is kept at 0.

After the SD card is bound with the SIM card through the solution of step 101 to step 108, the legal IMSI is stored in the SD card, meanwhile, in step 103, the SD server can also record the correspondence between the SD card and the SIM card, and thus when the SD card is lost or in an insecure environment, as long as the corresponding SIM card is logged off, the services in the SD card cannot be illegally used, so the security of the services of the SD card is improved.

### Second Embodiment

The second embodiment of the application specifies the binding method in the first embodiment by specific examples. Based on the first embodiment, the received information is further authenticated by algorithms at the SD card side and the SD server side, and the security of the services of the SD card is further improved.

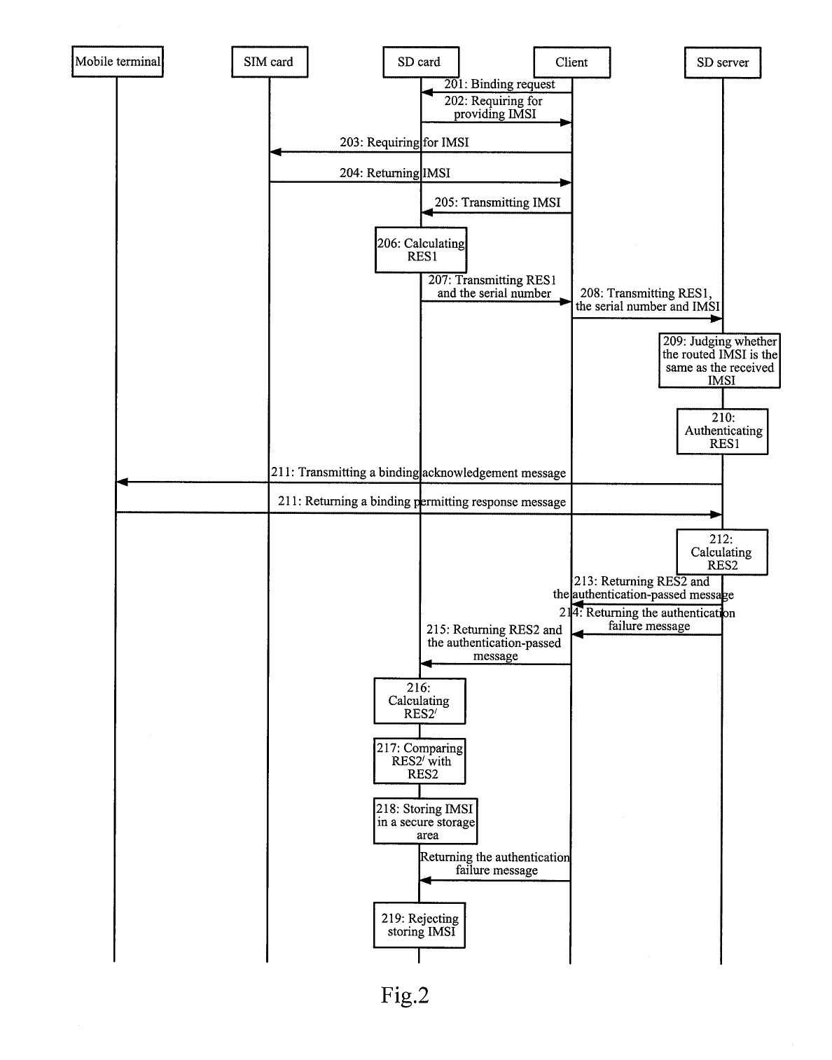

As shown in FIG. 2, which is a flow schematic diagram of binding an SD card and an SIM card in the second embodiment, the flow comprises the following steps:

Step 201: transmitting, by a client, a binding request to the SD card.

The client involved in the second embodiment can be the one defined in step 101 of the first embodiment.

Step 202: requiring, by the SD card, the client for providing IMSI.

Step 203: requiring, by the client, the SIM card for the IMSI.

Step 204: returning, by the SIM card, the IMSI to the client.

Step 205: transmitting, by the client, the IMSI to the SD card.

Step 206: performing, by the SD card, an operation on the received IMSI, a personal serial number and a preset key according to a first encryption algorithm to obtain a first authentication parameter RES1.

Step 207: transmitting, by the SD card, the RES1 and the personal serial number to the client.

In the solution of the embodiment, in order to avoid an illegal user transmitting an illegal binding operation request to the SD server by using a counterfeited SD card, in step 206, the SD card generates the RES1 related with the first encryption algorithm, the IMSI, the personal serial number and the preset key. Because the encryption algorithm and the preset key of the SD card are stored in the legal SD server, when the authentication on the RES1 carried out by the SD server passes subsequently, the binding operation of the SD card and the SIM card is a legal operation.

Step 208: transmitting, by the client, an authentication request to the SD server, wherein the authentication request contains the RES1, the IMSI and the serial number of the SD card.

Step 209: when receiving the authentication request, verifying, by the SD server, the serial number of the SD card and judging whether the IMSI used in the routing process of the authentication request is the same as that in the authentication request, if so, executing step 210; otherwise, executing step 214.

The object of the step is to ensure that when the mobile terminal is lost, after the user picking up the mobile terminal reads the IMSI in the logged SIM card and under the condition that the IMSI is carried in an authentication request and routed to the SD server through IMSI of another SIM card to counterfeit the logged SIM card, the SD server can also identify the illegal state.

Step 210: authenticating, by the SD server, the RES1 according to the IMSI and the serial number of the SD card in the authentication request, and if the authentication passes, executing step 211; otherwise, executing step 214.

The specific execution mode of the step is as follows:

Because the serial number of each SD card and a key and an encryption algorithm set in the SD card are stored in the SD server, the SD server can find out the encryption algorithm and the preset key used by the SD card according to the serial number in the authentication request. If a plurality of encryption algorithms and preset keys are set in the SD card, the encryption algorithm and the preset key for use can be consulted between the SD card and the SD server before the SD card leaves a factory, or information for expressing the encryption algorithm and the preset key used by the SD card is carried in the authentication request.

The SD server performs an operation on the IMSI in the authentication request, the serial number of the SD card and the found preset key according to the first encryption algorithm to obtain RES1/.

The SD server compares the obtained RES1/ from the operation with the RES1 in the authentication request, if the RES1/ is equal to the RES1, the SD server determines that the SD card required to be bound is a legal SD card, the binding operation is a legal binding operation, and the authentication on the RES1 passes; otherwise, the SD server determines that the SD card required to be bound is an illegal card or the SD card is in an insecure environment, and the authentication on the RES1 fails.

Step 210 corresponds to step 206, and the SD server authenticates the RES1 computed in step 206 by the SD card in step 210, so as to authenticate the identity of the SD card required to be bound with the SIM card.

Step 211: transmitting, by the SD server, a binding acknowledgement message to the mobile terminal, and when a binding permitting response message returned from the mobile terminal is received, executing step 212; otherwise, executing step 214.

The step is a manual acknowledgement step of the user, the SD server can transmit the binding acknowledgement message to the mobile terminal by a short message, and the user can reply an identifier of the binding permitting response message or an identifier of a binding rejecting response message in a short message, so that the SD server identifies whether the user permits the binding.

It should be explained that the process of transmitting the binding acknowledgement message to the mobile terminal and receiving the binding permitting response message returned from the mobile terminal can be executed before step 209, and when the binding permitting response message returned from the mobile terminal can be successfully received, it means that the identification number of the SIM installed in the mobile terminal transmitting the authentication request is the same as that of the SIM in the authentication request, namely the verification in step 209 passes.

Step 212: performing, by the SD server, an operation on the IMSI, the serial number of the SD card, the preset key and the RES1 according to a second encryption algorithm to obtain a second authentication parameter RES2.

The object of the step is similar to that of step 206, namely to avoid the illegal user transmitting a counterfeited authentication-passed message to the SD card by using a counterfeited SD server, so the SD server returns the RES2 related to the serial number of the SD card, the preset key and the second encryption algorithm to the SD card, and if the authentication on the RES2 carried out the SD card can pass, the SD card can trust that the SD server is a legal platform.

Step 213: returning, by the SD server, the RES2 and the authentication-passed message to the mobile terminal together, and skipping to step 215.

Step 214: returning, by the SD server, the authentication failure message to the mobile terminal, and skipping to step 219.

Step 215: transmitting, by the client, the received RES2 and the authentication-passed message to the SD card.

Step 216: performing, by the SD card, an operation on the IMSI, the personal serial number, the preset key and the RES1 through the second encryption algorithm to obtain RES2/.

Step 217: comparing, by the SD card, the received RES2 with the RES2/ obtained from the operation, and if the comparison result is that they are identical, executing step 218; otherwise, executing step 219.

Step 217 corresponds to step 211, the SD card authenticates the RES2 calculated in step 211 by the SD server in step 217 to authenticate the SD server returning the authentication-passed message, and when the authentication passes, the SD card determines that the received authentication-passed message is credible; otherwise, the SD card determines that the authentication-passed message is from an incredible channel.

Step 218: storing, by the SD card, the IMSI in a secure storage area to complete the binding operation with the SIM card, setting the mark position as 1, and ending.

Step 219: rejecting, by the SD card, storing the IMSI, which indicates that the binding operation with the SIM card fails, setting the mark position as 0, and ending.

Through the solution of the second embodiment, secure binding of the SD card and the SIM card is realized; in the binding process, the SD server authenticates the legality of the SIM card, and the SD card and the SD server respectively authenticate the legality of the opposite side, thereby avoiding that counterfeited illegal devices appear in the SD card, the SIM card and the SD server in the binding process of the SD card and the SIM card and improving the binding security; and further, in the binding process of the SD card and the SIM card, the manual determination process of the user is regarded as a part of security authentication, so that the security of the binding operation is further improved.

After the SD card is bound with the SIM card through the solutions of the first embodiment and the second embodiment, the services in the SD card can be operated; when the services in the SD card are operated, the security of the process for operating the services in the SD card is monitored by using the binding relationship between the SD card and the SIM card established in the first embodiment and the second embodiment, and the services in the SD card can be operated only when the SD card is in the secure environment, thereby avoiding the problem that the services in the SD card are used by the illegal user when the SD card is in the insecure environment due to loss of the mobile terminal and the like.

### Third Embodiment

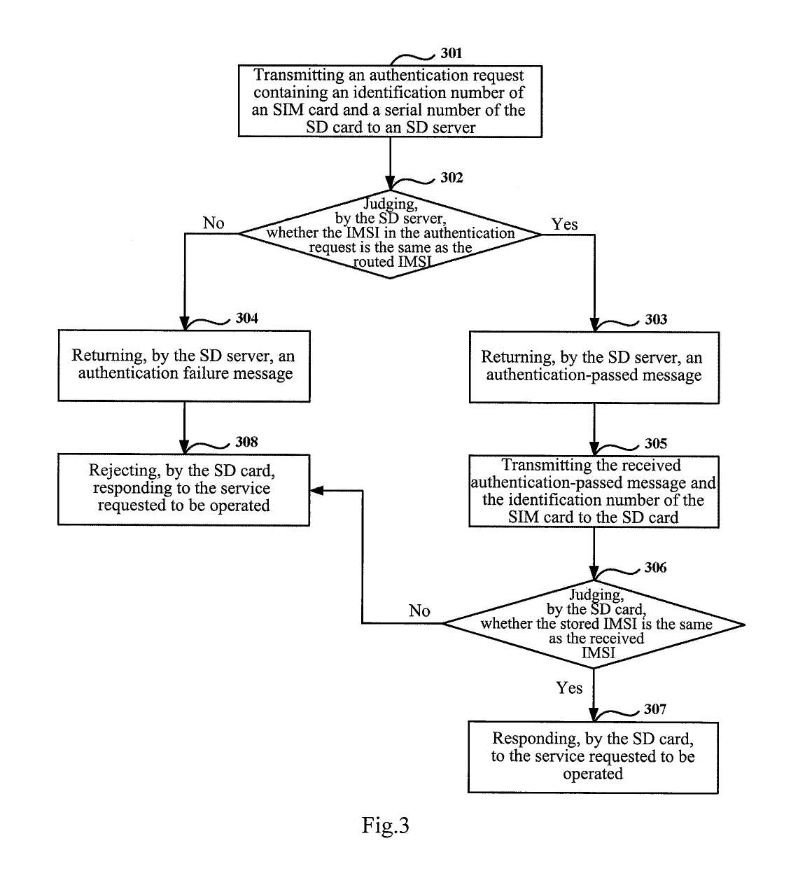

The third embodiment of the application is a method for operating the services in the SD card, and shown as FIG. 3, the method comprises the following steps:

Step 301: transmitting an authentication request containing an identification number of an SIM card and a serial number of the SD card to an SD server.

The execution main body of the step can be the client defined in step 101 of the first embedment, and when the SD card is installed in a mobile terminal, a user can initiate a service operating request to the SD card through the client.

After receiving the service operating request, the SD card checks the mark position for indicating the state; if the mark position is 0, which indicates that the SD card has not been bound with the SIM card at present, the solutions of the first embodiment and the second embodiment can be performed to carry out the binding operation; and if the mark position is 1, which indicates that the SD card has been bound with the SIM card, a binding relationship authentication message is returned to the client to require for verifying whether the SD card is in a secure environment at present.

After receiving the binding relationship authentication message, the client determines that the SD card has already established the binding relationship with the SIM card, then obtains IMSI from the SIM card and transmits the authentication request carrying the IMSI and the serial number of the SD card to the SD server.

Step 302: verifying, by the SD server, the serial number of the SD card and judging whether an identification number of an SIM card installed in a mobile terminal transmitting the authentication request is the same as the received identification number of the SIM card, if so, executing step 303; otherwise, executing step 304.

In the step, if the SD card is in the insecure environment, for example, the SD card is lost and picked up by others, the legal user of the SD card cannot timely log the services in the SD card off but can timely log the SIM card off, namely the SIM card bound with the SD card cannot be used. Therefore, if a pickup person reads the IMSI of the SIM card bound with the SD card through a tool and wants to use another SIM card to counterfeit the logged SIM card to use the services in the SD card, the SD server can determine that the SD card is in the insecure environment according to the difference between the IMSI of the SIM card used at present and the IMSI carried in the authentication request in the step.

Step 303: returning an authentication-passed message to the mobile terminal, and skipping to step 305.

Step 304: returning an authentication failure message to the mobile terminal, and skipping to step 308.

Step 305: transmitting the received authentication-passed message and the identification number of the SIM card to the SD card.

The execution main body of the step can be the client.

Step 306: judging, by the SD card, whether the personally stored identification number of the SIM card is the same as the received identification number of the SIM card, and if so, executing step 307; otherwise, executing step 308.

Step 307: responding, by the SD card, to the service requested to be operated, and ending.

Step 308: rejecting, by the SD card, responding to the service requested to be operated, and ending.

Through the solution of the third embodiment of the application, when the mobile terminal with the SD card and the SIM card installed therein is lost, as long as the SIM card is logged off, even if the pickup person reads the IMSI of the SIM card bound with the SD card, the authentication of the SD server still fails, thereby solving the problem that the services in the SD card is illegally used by others.

### Fourth Embodiment

The fourth embodiment of the application specifies the method for operating the SD card in the third embodiment through specific examples. Based on the third embodiment, the received information is further authenticated by algorithms at the SD card side and the SD server side, and the security is further improved when the services of the SD card is operated.

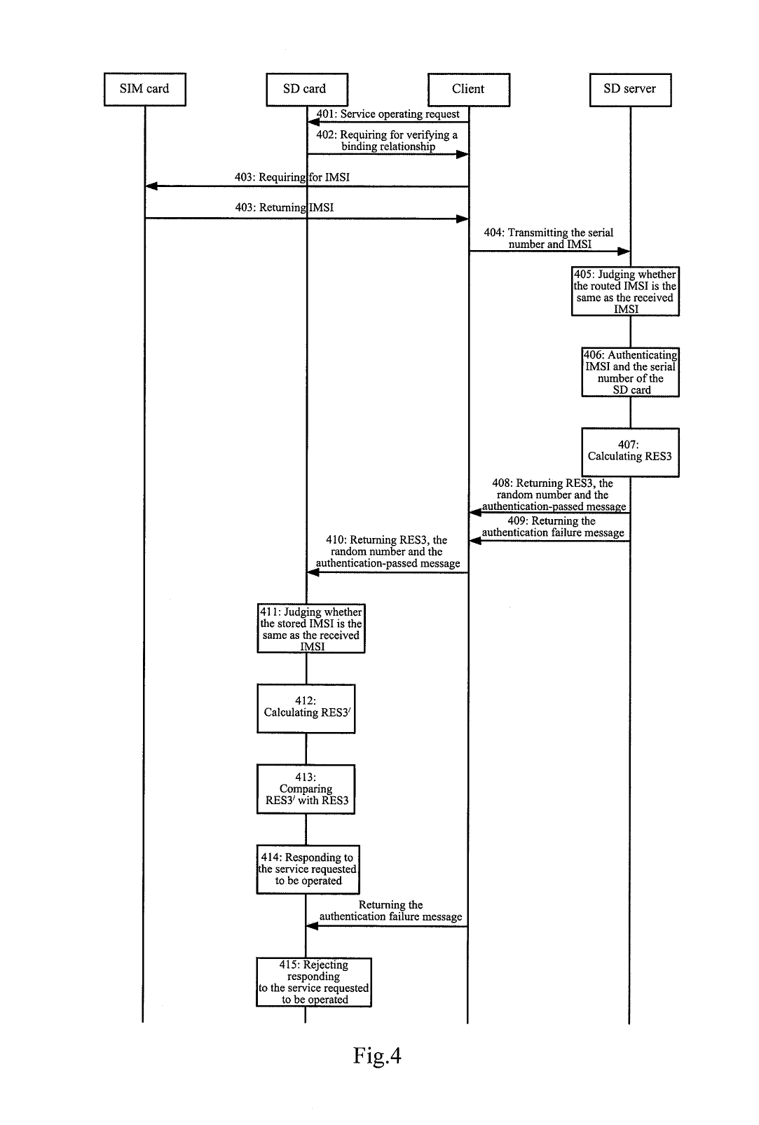

As shown in FIG. 4, which is a schematic diagram of a method for operating services in an SD card in the fourth embodiment of the application, the method comprises the following steps:

Step 401: transmitting, by a client, a service operating request to the SD card.

Step 402: returning, by the SD card, a binding relationship authentication message carrying a serial number of the SD card to the client.

Step 403: obtaining, by the client, IMSI from an SIM card.

Step 404: transmitting, by the client, an authentication request containing the IMSI and the serial number of the SD card to the SD server.

Step 405: judging, by the SD server, whether IMSI for routing is the same as the received IMSI, if so, executing step 406; otherwise, executing step 409.

Step 406: authenticating, by the SD server, the received IMSI and the serial number of the SD card according to a pre-stored correspondence between the IMSI and the serial number of the SD card, and if the authentication passes, executing step 407; otherwise, executing step 409.

In the binding solutions of the first embodiment and the second embodiment, the bound IMSI is stored in the SD card, and the correspondence between the serial number of the SD card which establishes the binding relationship and the IMSI is also stored in the SD server. When determining that the IMSI for routing is the same as the IMSI in the authentication request, the SD server side still cannot determine that the IMSI is the one of the SIM card bound with the SD card, and therefore after step 406, the SD server side further determining whether the current SD card is in the insecure environment.

Step 407: performing, by the SD server, an operation on the IMSI, the serial number of the SD card, a preset key and a random number according to a third encryption algorithm to obtain a third authentication parameter RES3.

In the step, after the SD server determines that the SD card is in the secure environment and the services in the SD card can be operated, the SD server shows personal legality to the SD card through the RES3 and requires the SD card to trust an authentication-passed message returned from the SD server after the authentication on the RES3 passes, thereby avoiding an illegal user transmitting a counterfeited authentication-passed message to the SD card by using a counterfeited SD server.

The purpose of calculating RES3 by using the random number in the step is that the operation for operating the service in the SD card is frequently executed, and if the RES3 calculated every time is identical, the illegal user can transmit the counterfeited authentication-passed message to the SD card by using the counterfeited SD server after intercepting the RES3 transmitted by the SD server when the service in the SD is operated normally, so the random number is used as a calculation parameter when the RES3 is calculated every time in order to avoid the above condition and improve the operating security of the service in the SD card.

Step 408: returning, by the SD server, the authentication-passed message, the third authentication parameter and the random number together, and skipping to step 410.

Step 409: returning, by the SD server, an authentication failure message, and skipping to step 415.

Step 410: transmitting, by the client, the authentication-passed message to the SD card.

Step 411: judging, by the SD card, whether the personally stored IMSI is the same as the received IMSI, and if so, executing step 412; otherwise, executing step 415.

Step 412: performing, by the SD card, an operation on the IMSI, the serial number, the preset key and the received random number according to the third encryption algorithm to obtain RES3/.

Step 413: comparing, by the SD card, the RES3/ with the RES3, and if the comparison result is that they are identical, executing step 414; otherwise, executing step 415.

Step 413 corresponds to step 407, and the SD card determines that the SD server transmitting the authentication-passed message is a credible platform by authenticating the RES3.

Step 414: responding, by the SD card, to the service requested to be operated, and ending.

Step 415: rejecting, by the SD card, responding to the service requested to be operated, and ending.

### Fifth Embodiment

The fifth embodiment of the application is a solution for further updating the service data in the SD card in the operating process of the third embodiment, and the steps of the fifth embodiment can be executed before step 301, or can be executed at any moment from step 301 to step 308, or can be executed after step 308.

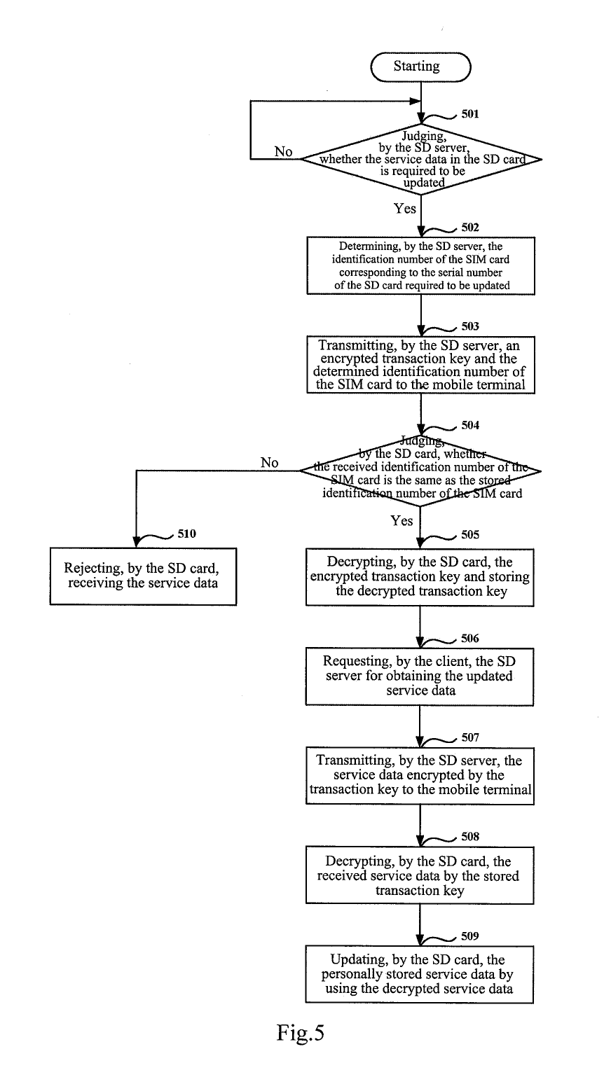

As shown in FIG. 5, the method of the fifth embodiment comprises the following steps:

Step 501: judging, by the SD server, whether the service data in the SD card is required to be updated at present, if so, executing step 502; otherwise, proceeding with the judgment operation of the step.

Step 502: determining, by the SD server, the identification number of the SIM card corresponding to the serial number of the SD card required to be updated according to the pre-stored correspondence between the identification number of the SIM card and the serial number of the SD card.

The SD server manages the service data in the SD card; when the service data is required to be upgraded and new service data is required to be transmitted to the SD card, the SD server determines the SIM card bound with the SD card and the mobile terminal where the SIM card locates according to the serial number of the SD card which is required to receive the updated service data, so as to transmit the updated service data to the SD card in the corresponding mobile terminal through the network routing capability of the SIM card subsequently.

In the step, the SD service platform has already recorded the correspondence between the serial number of the SD card and the IMSI in the binding operation on the SD card and the SIM card, so in the step, when the SD service platform determines that the service data in a certain SD card is required to be updated, the SD service platform queries the corresponding IMSI number according to the correspondence.

If the mobile terminal where the SD card locates is lost at this moment, namely the SD card is in an insecure state, the legal user of the mobile terminal, the SD card and the SIM card will instantly log off the SIM card; and thus, even if the SD server determines that the service data in a certain SD card is required to be updated, the service data updating operation in the embodiment cannot be executed because the SIM card bound with the SD card has already been logged off, so the SD card, the SIM card and the mobile terminal are in the secure environment during execution of the embodiment.

Step 503: transmitting, by the SD server, an encrypted transaction key and the determined identification number of the SIM card to the mobile terminal where the SIM card corresponding to the determined identification number of the SIM card locates.

In the embodiment, the SD server transmits the encrypted transaction key and the identification number of the SIM card to the SD card for the following three purposes:

1. In order to prevent the service data transmitted to the SD card by the SD server from being illegally intercepted and then misappropriated, the SD server transmits the encrypted transaction key to the SD card before transmitting the updated service data to the SD card, so that when the SD server encrypts the updated service data by the transaction key and then transmits the updated service data to the SD card, the SD card can accurately decrypt the updated service data, and other illegal users cannot misappropriate the updated service data when intercepting the updated service data.

2. The algorithms for encryption and decryption are previously defined between the legal SD card and the SD server, and the SD card capable of decoding the received transaction key is a legal SD card, so the SD server transmits the encrypted transaction key to the SD card to verify the legality of the SD card. If the current SD card is illegally counterfeited by another illegal SD card, the counterfeited SD card cannot decrypt the received updated service data subsequently because it cannot accurately decrypt the transaction key.

3. There may be a condition that the illegal user counterfeits the SD server to transmit the updated service data to the SD card, so the SD server transmits the IMSI to the SD card before transmitting the updated service data to the SD card, to make the SD card authenticate the SD server by using the received IMSI.

Step 504: judging, by the SD card, whether the received identification number of the SIM card is the same as the personally stored identification number of the SIM card, and if so, executing step 505; otherwise, executing step 510.

In step 503, after the encrypted transaction key and the identification number of the SIM card, which are transmitted by the SD server, arrive at the mobile terminal, the transaction key and the identification number of the SIM card are transmitted to the SD card by the client in the mobile terminal. The client can be the one involved in the first embodiment to the fourth embodiment.

In the step, the identification number of the SIM card in the SD card can be the stored identification number through the solutions of the first embodiment and the second embodiment.

Step 505: decrypting, by the SD card, the encrypted transaction key, storing the decrypted transaction key and informing the client of the message that the authentication on the SD server passes.

Step 506: requesting, by the client, the SD server for obtaining the updated service data.

Step 507: transmitting, by the SD server, the service data encrypted by the transaction key to the mobile terminal.

Step 508: transmitting, by the client, the received encrypted service data to the SD card, and decrypting, by the SD card, the received service data by the stored transaction key.

Step 509: updating, by the SD card, the personally stored service data by using the decrypted service data, and ending.

Step 510: informing, by the SD card, the client of the message that the authentication on the SD server fails, and rejecting receiving the service data, and ending.

Through the solution of the fifth embodiment of the application, when determining that the service data in the SD card is required to be updated, the SD service platform side intercommunicates the transaction key with the SD card side and further transmits the identification number of the SIM card to the SD card to require the SD card for authenticating the SD server according to the received identification number of the SIM card, so that on one hand, the security of service data transmission is improved, and one the other hand, the condition that the illegal SD server transmits the illegal service data to the SD card is also avoided.

### Sixth Embodiment

The sixth embodiment of the application specifies the method for updating the service data in the SD card in the fifth embodiment of the application through specific examples. Based on the fifth embodiment, the SD server side proves personal legality to the SD card by algorithms, so that the security when the service data in the SD card is updated is further improved.

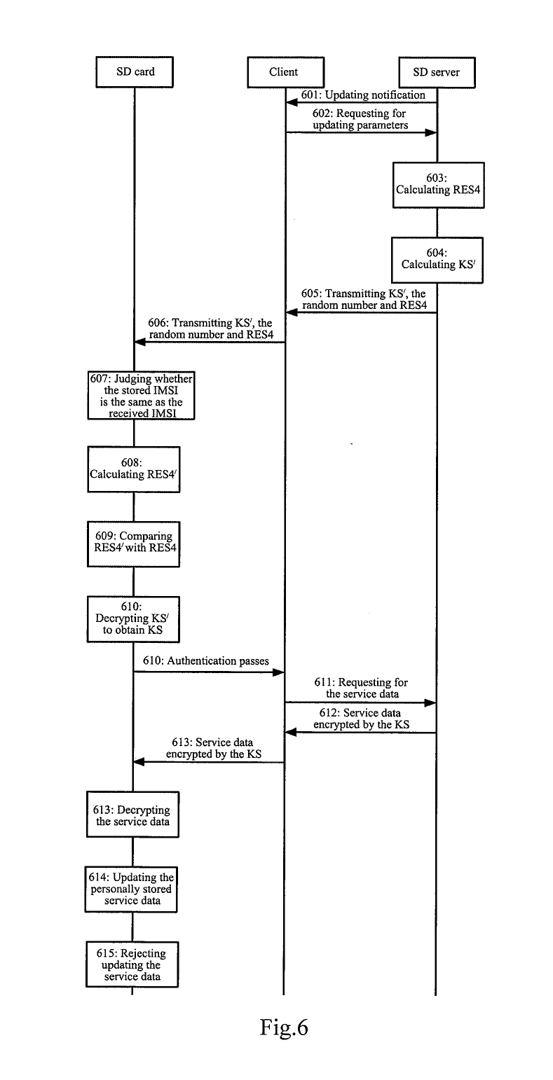

As shown in FIG. 6, which is a schematic diagram of a method for updating the service data in the SD card in the sixth embodiment of the application, the method comprises the following steps:

Step 601: transmitting, by the SD server, an updating notification to the mobile terminal where the SD card locates when the service data in the SD card is required to be updated.

Step 602: requesting, by the client in the mobile terminal, the SD server for updating parameters.

The client involved in this embodiment can be the same one in the first embodiment to the fifth embodiment.

In the embodiment, when the service data in the SD card is required to be updated, the SD card does not instantly request the SD server for downloading the updated service data, but requests for downloading the updating parameters to prove the legality of the SD server and improve the security of service data transmission.

Step 603: determining, by the SD server, a fourth authentication parameter RES4 according to the random number, the preset key, the determined serial number of the SD card and the IMSI.

In the step, the SD server shows personal legality to the SD card through the RES4 and requires the SD card for trusting the SD server when the authentication on the RES4 passes, thereby avoiding the illegal user transmitting counterfeited service date to the SD card by using a counterfeited SD server.

The purpose of calculating the RES4 by using the random number in the step is that the operation for updating the service data in the SD card is frequently executed, and if the RES4 calculated every time is identical, the illegal user can counterfeit the legal SD server by using a counterfeited SD server after intercepting the RES4 transmitted by the SD server when the service data in the SD card is updated normally, so the random number is used as a calculation parameter when the RES4 is calculated every time in order to avoid the above condition and improve the security of updating the service data in the SD card.

Step 604: determining, by the SD server, a transaction key KS, and encrypting the KS to obtain KS/.

The execution sequence of step 603 and step 604 is not limited, and step 604 can be firstly executed, or step 603 and step 604 are executed at the same time.

Step 605: transmitting, by the SD server, the KS/, the random number and the RES4 to the mobile terminal.

Step 606: transmitting, by the client, the KS/, the random number and the RES4 to the SD card.

Step 607: judging, by the SD card, whether the received IMSI is the same as the personally stored IMSI, if so, executing step 608; otherwise, executing step 615.

Step 608: calculating, by the SD card, an RES4/ by using the stored IMSI, the personal serial number, the preset key and the received random number.

Step 609: judging, by the SD card, whether the RES4 is the same as the RES4/, if so, executing step 609; otherwise, executing step 615.

Step 610: decrypting, by the SD card, the KS/, storing the KS, and informing the client of the message that the authentication on the SD server passes.

Step 611: requesting, by the client, the SD server for the service data.

Step 612: transmitting, by the SD server, the service data encrypted by the KS to the mobile terminal.

Step 613: transmitting, by the client, the received encrypted service data to the SD card, and decrypting, by the SD card, the received service data by the KS.

Step 614: updating, by the SD card, the personally stored service data by using the decrypted service data, and ending.

Step 615: informing, by the SD card, the client of the message that the authentication on the SD server fails, rejecting updating the service data, and ending.

### Seventh Embodiment

The seventh embodiment of the application provides a system for binding an SD card and an SIM card, the SD card, a client and an SD server belonging to the same inventive concept as the first embodiment and the second embodiment, which are respectively illustrated as follows:

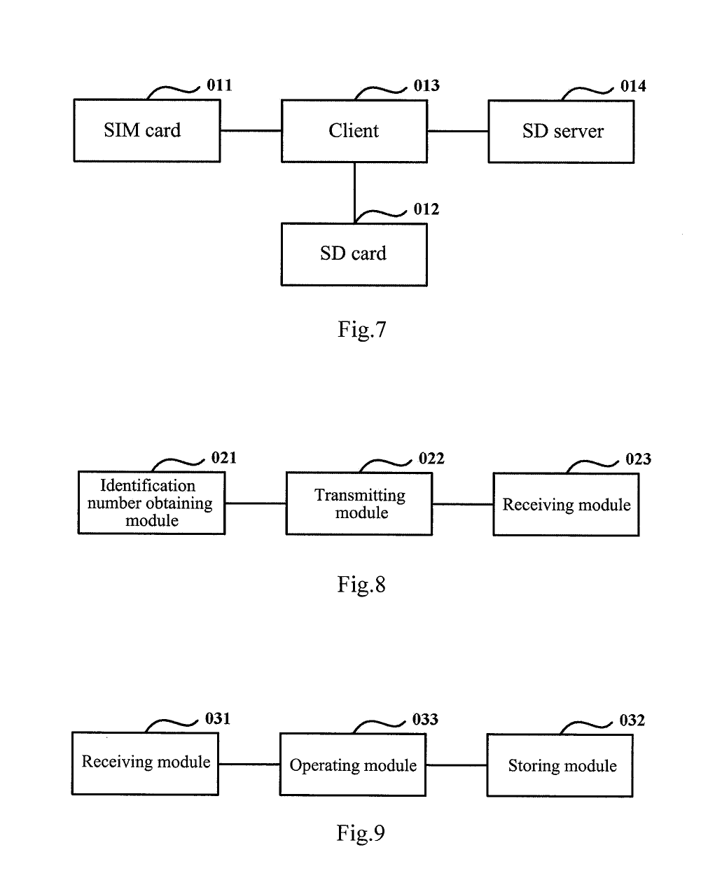

As shown in FIG. 7, which is a structural schematic diagram of the system for binding the SD card and the SIM card, the system comprises an SIM card 011, an SD card 012, a client 013 and an SD server 014, wherein the client 013 is used for obtaining an identification number of the SIM card from the SIM card 011, transmitting the identification number of the SIM card to the SD card 012, receiving a serial number returned from the SD card 012, transmitting an authentication request carrying the identification number of the SIM card and the serial number of the SD card to the SD server 014 and transmitting a received authentication-passed message returned from the SD server 014 to the SD card 012; the SD server 014 is used for verifying the serial number of the SD card and returning the authentication-passed message after determining that an identification number of an SIM card installed in a mobile terminal transmitting the authentication request is the same as that of the SIM card in the authentication request; and the SD card 012 is used for storing the identification number of the SIM card after receiving the authentication-passed message.

The SD card 012 is further used for determining a first authentication parameter according to the received identification number of the SIM card, the personal serial number and a preset key and transmitting the first authentication parameter to the client 013; and the client 013 is specifically used for transmitting the authentication request containing the first authentication parameter, the identification number of the SIM card and the serial number of the SD card to the SD server.

The SD server 014 is specifically used for authenticating the received first authentication parameter according to the received identification number of the SIM card and the serial number of the SD card and returning the authentication-passed message when the authentication passes.

The SD server 014 is further used for performing an operation on the received identification number of the SIM card, the serial number of the SD card, the preset key and the first authentication parameter to obtain a second authentication parameter and returning the second authentication parameter and the authentication-passed message together.

The SD card 012 is further used for performing an operation on the identification number of the SIM card, the personal serial number, the preset key and the determined first authentication parameter when receiving the second authentication parameter and the authentication-passed message and storing the received identification number of the SIM card when the operation result is the same as the received second authentication parameter.

The SD server 014 is further used for transmitting a binding acknowledgement message to the mobile terminal with the SIM card corresponding to the identification number installed therein according to the received identification number of the SIM card and receiving a binding permitting response message returned from the mobile terminal.

The SIM card 011, the SD card 012, the client 013 and the SD server 014 in the system of the embodiment can realize the function of each step in the first embodiment and the second embodiment.

As shown in FIG. 8, which is a structural schematic diagram of the client for binding the SD card and the SIM card in the seventh embodiment, the client comprises an identification number obtaining module 021, a transmitting module 022 and a receiving module 023, wherein the identification number obtaining module 021 is used for obtaining the identification number of the SIM card from the SIM card and receiving the serial number transmitted from the SD card; the transmitting module 022 is used for transmitting the identification number of the SIM card to the SD card, transmitting the authentication request carrying the identification number of the SIM card and the serial number of the SD card to the SD server, to request the SD server to verify the serial number of the SD card and return the authentication-passed message after determining that the identification number of the SIM card installed in the mobile terminal transmitting the authentication request is the same as that of the SIM card in the authentication request; and the receiving module 023 is used for indicating the SD card to store the identification number of the SIM card after receiving the authentication-passed message returned from the SD server.

The receiving module 023 is further used for receiving the first authentication parameter returned from the SD card, where the first authentication parameter is determined by the SD card through an operation according to the received identification number of the SIM card, the personal serial number and the preset key; and the transmitting module 022 is specifically used for transmitting the authentication request containing the first authentication parameter, the identification number of the SIM card and the serial number of the SD card to the SD server, to request the SD server for authenticating the received first authentication parameter according to the received identification number of the SIM card and the serial number of the SD card and return the authentication-passed message when the authentication passes.

The receiving module 023 is further used for receiving a second authentication parameter returned from the SD server and transmitting the second authentication parameter to the SD card, where the second authentication parameter is determined by the SD server through an operation according to the received identification number of the SIM card, the serial number of the SD card, the preset key and the first authentication parameter.

As shown in FIG. 9, which is a structural schematic diagram of the SD card in the seventh embodiment of the application, the SD card comprises a receiving module 031 and a storing module 032, wherein the receiving module 031 is used for receiving the identification number of the SIM card and the authentication-passed message indicating that the identification number is permitted to be stored; and the storing module 032 is used for storing the identification number of the SIM card after receiving the authentication-passed message.

The SD card further comprises an operating module 033 used for determining the first authentication parameter through an operation according to the received identification number of the SIM card, the personal serial number and the preset key, and transmitting the first authentication parameter.

The receiving module 031 is specifically used for receiving the second authentication parameter and the authentication-passed message; and the storing module 032 is specially used for performing an operation on the identification number of the SIM card, the personal serial number, the preset key and the determined first authentication parameter, and storing the received identification number of the SIM card when the operation result is the same as the received second authentication parameter.

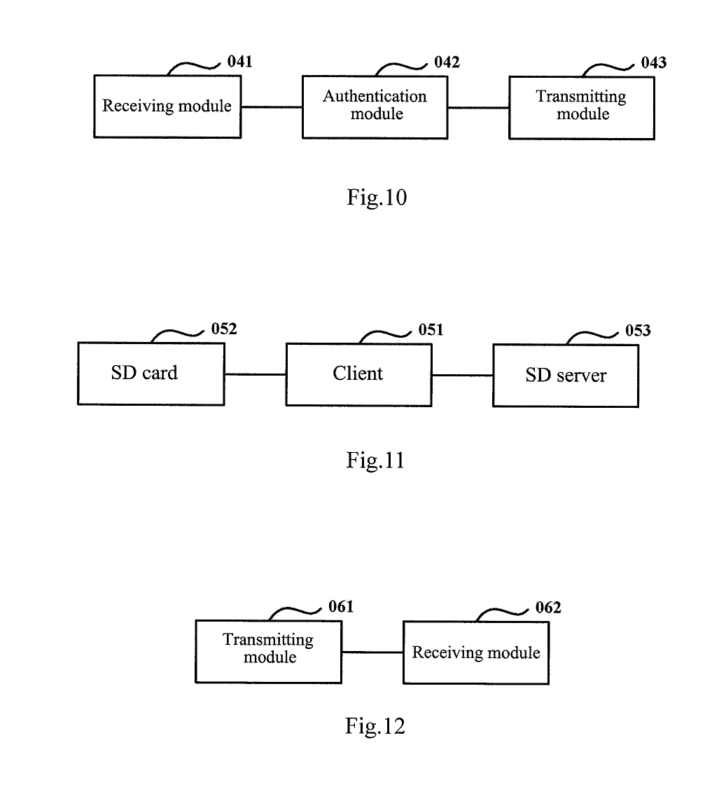

As shown in FIG. 10, which is a structural schematic diagram of the SD server in the seventh embodiment of the application, the SD server comprises a receiving module 041, an authentication module 042 and a transmitting module 043, wherein the receiving module 041 is used for receiving the authentication request carrying the identification number of the SIM card and the serial number of the SD card; the authentication module 042 is used for verifying the serial number of the SD card and determining whether the identification number of the SIM card installed in the mobile terminal transmitting the authentication request is the same as that of the SIM card in the authentication request; and the transmitting module 043 is used for returning the authentication-passed message after determining that the identification number of the SIM card installed in the mobile terminal transmitting the authentication request is the same as that of the SIM card in the authentication request.

The receiving module 041 is specifically used for receiving the authentication request containing the first authentication parameter, the identification number of the SIM card and the serial number of the SD card, wherein the first authentication parameter is determined by the SD card through the operation according to the identification number of the SIM card, the personal serial number and the preset key; the authentication module 042 is specifically used for determining whether the identification number of the SIM card installed in the mobile terminal transmitting the authentication request is the same as that of the SIM card in the authentication request and authenticating the received first authentication parameter according to the received identification number of the SIM card and the serial number of the SD card; and the transmitting module 043 is specifically used for returning the authentication-passed message after determining that the identification number of the SIM card installed in the mobile terminal transmitting the authentication request is the same as that of the SIM card in the authentication request and the authentication on the first authentication parameter passes.

The transmitting module 043 is further used for returning the second authentication parameter and the authentication-passed message together, where the second authentication parameter is determined by the operation according to the identification number of the SIM card, the serial number of the SD card, the preset key and the first authentication parameter.

The transmitting module 043 is further used for transmitting the binding acknowledgement message to the mobile terminal with the SIM card corresponding to the identification number installed therein according to the received identification number of the SIM card, and receiving the binding permitting response message returned from the mobile terminal.

The SD card, the client and the SD server in the seventh embodiment of the application are further provided with logic modules capable of realizing the functions of the steps in the first embodiment and the second embodiment. Repeated description is omitted herein.

### Eighth Embodiment

The eighth embodiment of the application provides a system, an SD card, a client and an SD server belonging to the same inventive concept as the third embodiment, the fourth embodiment, the fifth embodiment and the sixth embodiment, which are respectively illustrated as follows:

As shown in FIG. 11, which is a structural schematic diagram of the system for operating the SD card in the eighth embodiment of the application, the system comprises a client 051, an SD card 052 and an SD server 053, wherein the client 051 is used for transmitting an authentication request containing the identification number of the SIM card and the serial number of the SD card to the SD server 053 and transmitting the received authentication-passed message, the authentication failure message and the identification number of the SIM card to the SD card 052; the SD server 053 is used for verifying the serial number of the SD card, and returning the authentication-passed message after determining that the identification number of the SIM card installed in the mobile terminal transmitting the authentication request is the same as the received identification number of the SIM card, otherwise, returning the authentication failure message; and the SD card 052 is used for responding to the service requested to be operated after receiving the authentication-passed message and determining that the personally stored identification number of the SIM card is the same as the received identification number of the SIM card, or rejecting responding to the service requested to be operated after determining that the personally stored identification number of the SIM card is different from the received identification number of the SIM card or receiving the returned authentication failure message.

The SD server 053 is further used for authenticating the received identification number of the SIM card and the serial number of the SD card 052 according to the pre-stored correspondence between the identification number of the SIM card and the serial number of the SD card 052 and returning the authentication-passed message when the authentication passes.

The SD server 053 is further used for determining a third authentication parameter through an operation according to the random number, the preset key, the received identification number of the SIM card and the serial number of the SD card and returning the authentication-passed message, the third authentication parameter and the random number together.

The SD card 052 is further used for performing an operation according to the identification number of the SIM card, the personal serial number, the preset key and the received random number, comparing the operation result with the received third authentication parameter and responding to the service requested to be operated when the comparison result is that they are identical.

The SD server 053 is further used for determining the identification number of the SIM corresponding to the serial number of the SD card required to update service data according to the pre-stored correspondence between the identification number of the SIM and the serial number of the SD card after the service data in the SD card is required to be updated, transmitting the encrypted transaction key and the determined identification number of the SIM to the mobile terminal where the SIM corresponding to the determined identification number of the SIM locates, and transmitting the service data encrypted by the transaction key to the mobile terminal; and the SD card 052 is further used for decrypting the encrypted transaction key and storing the decrypted transaction key after determining that the received identification number of the SIM is the same as that of the SIM installed in the mobile terminal, decrypting the received service data by the stored transaction key and updating the service data stored in the SD card by using the decrypted service data.

The SD server 053 is further used for determining a fourth authentication parameter through an operation according to the random number, the preset key, the determined serial number of the SD card and the identification number of the SIM card, and transmitting the encrypted transaction key, the fourth authentication parameter and the random number; and the SD card 052 is further used for authenticating the fourth authentication parameter by using the stored identification number of the SIM card, the serial number of the SD card, the preset key and the received random number and decrypting and storing the transaction key after the authentication passes.

The SIM card, the SD card, the client and the SD server in the system of the embodiment can realize the functions of the steps in the third embodiment, the fourth embodiment, the fifth embodiment and the sixth embodiment.

As shown in FIG. 12, which is a structural schematic diagram of the client for operating the SD card in the eighth embodiment of the application, the client comprises a transmitting module 061 and a receiving module 062, wherein the transmitting module 061 is used for transmitting the authentication request containing the identification number of the SIM card and the serial number of the SD card to the SD server and transmitting the identification number of the SIM card and the received authentication-passed message or authentication failure message to the SD card; and the receiving module 062 is used for receiving the authentication-passed message or the authentication failure message returned from the SD server.

The receiving module 062 is specifically used for receiving the third authentication parameter, the random number and the authentication-passed message, where the third authentication parameter is determined by the SD server through an operation according to the random number, the preset key, the received identification number of the SIM card and the serial number of the SD card; and the transmitting module 061 is used for transmitting the third authentication parameter, the random number and the authentication-passed message to the SD card together.

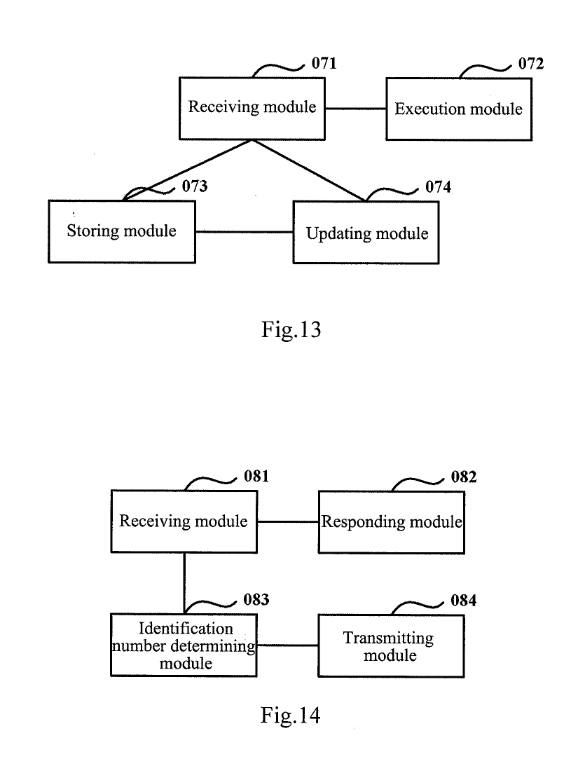

As shown in FIG. 13, which is a structural schematic diagram of the SD card in the eighth embodiment of the application, the SD card comprises a receiving module 071 and an execution module 072, wherein the receiving module 071 is used for receiving the identification number of the SIM card and the authentication-passed message or the authentication failure message; and the execution module 072 is used for responding to the service requested to be operated if the personally stored identification number of the SIM card is the same as the received identification number of the SIM card after receiving the identification number of the SIM card and the authentication-passed message; or rejecting responding to the service requested to be operated after the personally stored identification number of the SIM card is different from the received identification number of the SIM card or receiving the returned authentication failure message.

The receiving module 071 is further used for receiving the third authentication parameter and the random number, wherein the third authentication parameter is determined by the SD server through the operation according to the random number, the preset key, the received identification number of the SIM card and the serial number of the SD card; and the execution module 072 is further used for performing an operation according to the identification number of the SIM card, the personal serial number, the preset key and the received random number, comparing the operation result with the received third authentication parameter, and responding to the service requested to be operated after the comparison result is that they are identical.

The receiving module 071 is further used for receiving the encrypted transaction key and the identification number of the SIM card, and the service data encrypted by the transaction key transmitted from the SD server.

The SD card further comprises a storing module 073 and an updating module 074, wherein the storing module 073 is used for decrypting the encrypted transaction key and storing the decrypted transaction key after determining that the received identification number of the SIM card is the same as the personally stored identification number of the SIM card; and the updating module 074 is used for decrypting the received service data by the stored transaction key and updating the service data stored in the SD card by using the decrypted service data.

The receiving module 071 is further used for receiving the fourth authentication parameter and the random number sent by the SD server, wherein the fourth authentication parameter is determined by the SD server through the operation according to the random number, the preset key, the determined serial number of the SD card and the identification number of the SIM card; and the storing module 073 is further used for authenticating the fourth authentication parameter by using the stored identification number of the SIM card, the serial number of the SD card, the preset key and the received random number, and decrypting and storing the transaction key when the authentication passes.

As shown in FIG. 14, which is a structural schematic diagram of the SD server in the eighth embodiment of the application, the SD server comprises a receiving module 081 and a responding module 082, wherein the receiving module 081 is used for receiving the authentication request containing the identification number of the SIM card and the serial number of the SD card; and the responding module 082 is used for verifying the serial number of the SD card, and returning the authentication-passed message after determining that the identification number of the SIM card installed in the mobile terminal transmitting the authentication request is the same as the received identification number of the SIM card, otherwise, returning the authentication failure message.

The responding module 082 is further used for authenticating the received identification number of the SIM card and the serial number of the SD card according to the pre-stored correspondence between the identification number of the SIM card and the serial number of the SD card and returning the authentication-passed message after the authentication passes.

The responding module 082 is further used for determining the third authentication parameter through the operation according to the random number, the preset key, the received identification number of the SIM card and the serial number of the SD card, and returning the authentication-passed message, the third authentication parameter and the random number together.

The SD server further comprises an identification number determining module 083 and a transmitting module 084, wherein the identification number determining module 083 is used for determining the identification number of the SIM card corresponding to the serial number of the SD card required to be updated according to the pre-stored correspondence between the identification number of the SIM card and the serial number of the SD card when the service data in the SD card is required to be updated; and the transmitting module 084 is used for transmitting the encrypted transaction key and the determined identification number of the SIM card to the mobile terminal where the SIM card corresponding to the determined identification number of the SIM card locates, and transmitting the service data encrypted by the transaction key to the mobile terminal.

The transmitting module 084 is further used for determining the fourth authentication parameter by the operation according to the random number, the preset key, the determined serial number of the SD card and the identification number of the SIM card, and transmitting the fourth authentication parameter and the random number to the mobile terminal.

The SD card, the client and the SD server in the eighth embodiment of the application are further provided with logic modules capable of realizing the functions of the steps in the third embodiment, the fourth embodiment, the fifth embodiment and the sixth embodiment. Repeated description is omitted herein.

The systems in the seventh embodiment and the eighth embodiment of the application can be integrated together to form a system with the functions of binding the SD card and the SIM card, operating the SD card and updating the service data in the SD card.

The SD servers, the SD cards and the clients in the seventh embodiment and the eighth embodiment of the application can be integrated together to form devices with the functions of binding the SD card and the SIM card, operating the SD card and updating the service data in the SD card.

Through the method, the system and the device for binding the SD card and the SIM card and the method, the system and the device for operating the SD card, which are provided in the embodiments of the application, when the mobile terminal with the SD card and the SIM card installed therein is lost, as long as the SIM card is instantly logged off, the services in the SD card cannot be misappropriated by the illegal user, and the service data in the SD card cannot be updated any more, so that the security of the service data in the SD card is improved and the condition that the services are misappropriated when the SD card is in the insecure environment is avoided; and meanwhile, when the SD card is bound with the SIM card, the SD card is operated and the service data in the SD card are updated in the embodiments of the application, the SD card and the SD server respectively authenticate the identity of the opposite side through the RES obtained by operation and authenticate whether the SD card is in the secure environment, so that the execution security of various services in the SD card is further improved.

The above embodiments are only preferred embodiments of the application and are not used for limiting the application, and any modification, equivalent replacement, improvement and the like within the spirit and the principle of the application should be encompassed in the protective scope of the application.

1. A method for binding a secure digital (SD) memory card and a subscriber identity module (SIM), comprising:
transmitting an identification number of the SIM, obtained from the SIM, to the SD card;
receiving a serial number returned from the SD card, and transmitting an authentication request carrying the identification number of the SIM and the serial number of the SD card to an SD server, to request the SD server to verify the serial number of the SD card and return an authentication-passed message after determining that an identification number of an SIM, installed in a mobile terminal transmitting the authentication request, is the same as the identification number of the SIM in the authentication request; and
indicating the SD card to store the identification number of the SIM after receiving the authentication-passed message returned from the SD server.

2. The method of claim 1, wherein after transmitting the identification number of the SIM to the SD card and before transmitting the authentication request to the SD server, the method further comprises:
receiving a first authentication parameter returned from the SD card, wherein the first authentication parameter is determined by the SD card through an operation according to the received identification number of the SIM, the personal serial number and a preset key;
transmitting the authentication request to the SD server specifically comprises:
transmitting the authentication request, containing the first authentication parameter, the identification number of the SIM and the serial number of the SD card, to the SD server; and
after determining, by the SD server, that the identification number of the SIM, installed in the mobile terminal transmitting the authentication request, is the same as the identification number of the SIM in the authentication request and before returning the authentication-passed message, the method further comprises:
authenticating, by the SD server, the received first authentication parameter according to the received identification number of the SIM and the serial number of the SD card, and returning the authentication-passed message after the authentication passes.

3. The method of claim 2, wherein authenticating, by the SD server, the received first authentication parameter and returning the authentication-passed message after the authentication passes specifically comprises:
performing, by the SD server, an operation on the received identification number of the SIM, the serial number of the SD card and a preset key, comparing the operation result with the received first authentication parameter and returning the authentication-passed message after the comparison result is that they are identical.

4. The method of claim 3, wherein after determining, by the SD server, that the comparison result is that they are identical and before returning the authentication-passed message, the method further comprises:
performing, by the SD server, an operation on the received identification number of the SIM, the serial number of the SD card, the preset key and the first authentication parameter to obtain a second authentication parameter;
returning, by the SD server, the authentication-passed message specifically comprises:
returning, by the SD server, the second authentication parameter and the authentication-passed message together; and
storing, by the SD card, the identification number of the SIM according to the indication specifically comprises:
performing, by the SD card, an operation on the identification number of the SIM, the personal serial number, the preset key and the determined first authentication parameter, and storing the received identification number of the SIM when the operation result is the same as the second authentication parameter.

5. The method of claim 1, wherein determining, by the SD server, that the identification number of the SIM, installed in the mobile terminal transmitting the authentication request, is the same as the identification number of the SIM in the authentication request in the following mode:
querying, by the SD server, the identification number used by the SIM installed in the mobile terminal transmitting the authentication request in the routing process of transmitting the authentication request; and
comparing the queried identification number with the identification number of the SIM in the authentication request, and determining that the identification number of the SIM, installed in the mobile terminal transmitting the authentication request, is the same as the identification number of the SIM in the authentication request when the comparison result is that they are identical.

6. The method of claim 1, wherein determining, by the SD server, that the identification number of the SIM, installed in the mobile terminal transmitting the authentication request, is the same as the identification number of the SIM in the authentication request in the following mode:
transmitting, by the SD server, a binding acknowledgement message to the mobile terminal with the SIM corresponding to the identification number installed therein according to the received identification number of the SIM, and determining that the identification number of the SIM, installed in the mobile terminal transmitting the authentication request, is the same as the identification number of the SIM in the authentication request after receiving a binding permitting response message returned from the mobile terminal.

7. A method for operating an SD card, comprising:
transmitting an authentication request containing an identification number of an SIM and a serial number of the SD card to an SD server, to request the SD server to verify the serial number of the SD card and return an authentication-passed message after determining that an identification number of an SIM, installed in a mobile terminal transmitting the authentication request, is the same as the identification number of the SIM contained in the received authentication request, otherwise, return an authentication failure message; and
transmitting the received authentication-passed message containing the identification number of the SIM to the SD card, to indicate the SD card to respond to services requested to be operated after determining that the personally stored identification number of the SIM is the same as the received identification number of the SIM, otherwise, reject responding to the services requested to be operated; or
transmitting the received authentication failure message to the SD card, to indicate the SD card to reject responding to the services requested to be operated.

8. The method of claim 7, wherein before transmitting the authentication request to the SD server, the method further comprises:
initiating a service operating request to the SD card, and determining that a binding relationship between the SD card and the SIM has already been established according to a binding relationship authentication message returned from the SD card.

9. The method of claim 7, wherein after determining, by the SD server, that the identification number of the SIM, installed in the mobile terminal transmitting the authentication request, is the same as the received identification number of the SIM and before returning the authentication-passed message, the method further comprises:
authenticating, by the SD server, the received identification number of the SIM and the serial number of the SD card according to a pre-stored correspondence between the identification number of the SIM and the serial number of the SD card, and returning the authentication-passed message after the authentication passes.

10. The method of claim 9, wherein after the authentication performed by the SD server on the received identification number of the SIM and the serial number of the SD card passes and before returning the authentication-passed message, the method further comprises:
determining, by the SD server, a third authentication parameter according to a random number, a preset key, the received identification number of the SIM and the serial number of the SD card; and
returning, by the SD server, the authentication-passed message, the third authentication parameter and the random number together; and
after determining, by the SD card, that the personally stored identification number of the SIM is the same as the received identification number of the SIM and before responding, by the SD card, to the services requested to be operated, the method further comprises:
performing, by the SD card, an operation according to the identification number of the SIM, the personal serial number, the preset key and the received random number, comparing the operation result with the third authentication parameter, and responding to the services requested to be operated after the comparison result is that they are identical.

11. The method of claim 7, further comprising:
determining, by the SD server, the identification number of the SIM corresponding to the serial number of the SD card required to update service data according to the pre-stored correspondence between the identification number of the SIM and the serial number of the SD card when the service data in the SD card is required to be updated;
transmitting, by the SD server, an encrypted transaction key and the determined identification number of the SIM to the mobile terminal with the SIM corresponding to the determined identification number of the SIM, and indicating the SD card installed in the mobile terminal to decrypt the encrypted transaction key and store the decrypted transaction key after determining that the received identification number of the SIM is the same as the identification number of the SIM installed in the mobile terminal; and
transmitting, by the SD server, service data encrypted by the transaction key to the mobile terminal, and indicating the SD card installed in the mobile terminal to decrypt the received service data by the stored transaction key and update the service data stored in the SD card by using the decrypted service data.

12. The method of claim 11, wherein after determining, by the SD server, the identification number of the SIM corresponding to the serial number of the SD card required to be updated and before transmitting the encrypted transaction key to the mobile terminal, the method further comprises:
determining, by the SD server, a fourth authentication parameter according to the random number, the preset key, the determined serial number of the SD card and the identification number of the SIM; and
transmitting, by the SD server, the encrypted transaction key, the fourth authentication parameter and the random number to the mobile terminal together; and
after determining, by the SD card, that the received identification number of the SIM is the same as the personally stored identification number of the SIM and before decrypting the encrypted transaction key and storing the decrypted transaction key, the method further comprises:
authenticating, by the SD card, the fourth authentication parameter by using the stored identification number of the SIM, the serial number of the SD card, the preset key and the received random number, and decrypting and storing the transaction key after the authentication passes.

13. A system for binding an SD card and an SIM, comprising the SIM, the SD card, a client and an SD server, wherein,
the client is used for obtaining an identification number of the SIM from the SIM, transmitting the identification number of the SIM to the SD card, receiving a serial number returned from the SD card, transmitting an authentication request carrying the identification number of the SIM and the serial number of the SD card to the SD server and transmitting a received authentication-passed message returned from the SD server to the SD card;
the SD server is used for verifying the serial number of the SD card and returning the authentication-passed message after determining that an identification number of an SIM, installed in a mobile terminal transmitting the authentication request, is the same as the identification number of the SIM in the authentication request; and
the SD card is used for transmitting the personal serial number to the client and storing the identification number of the SIM after receiving the authentication-passed message.

14. (canceled)

15. (canceled)

16. (canceled)

17. (canceled)

18. (canceled)

19. (canceled)

20. (canceled)

21. (canceled)

22. (canceled)

23. (canceled)

24. The method of claim 8, further comprising:
determining, by the SD server, the identification number of the SIM corresponding to the serial number of the SD card required to update service data according to the pre-stored correspondence between the identification number of the SIM and the serial number of the SD card when the service data in the SD card is required to be updated;
transmitting, by the SD server, an encrypted transaction key and the determined identification number of the SIM to the mobile terminal with the SIM corresponding to the determined identification number of the SIM, and indicating the SD card installed in the mobile terminal to decrypt the encrypted transaction key and store the decrypted transaction key after determining that the received identification number of the SIM is the same as the identification number of the SIM installed in the mobile terminal; and
transmitting, by the SD server, service data encrypted by the transaction key to the mobile terminal, and indicating the SD card installed in the mobile terminal to decrypt the received service data by the stored transaction key and update the service data stored in the SD card by using the decrypted service data.

25. The method of claim 9, further comprising:
determining, by the SD server, the identification number of the SIM corresponding to the serial number of the SD card required to update service data according to the pre-stored correspondence between the identification number of the SIM and the serial number of the SD card when the service data in the SD card is required to be updated;
transmitting, by the SD server, an encrypted transaction key and the determined identification number of the SIM to the mobile terminal with the SIM corresponding to the determined identification number of the SIM, and indicating the SD card installed in the mobile terminal to decrypt the encrypted transaction key and store the decrypted transaction key after determining that the received identification number of the SIM is the same as the identification number of the SIM installed in the mobile terminal; and
transmitting, by the SD server, service data encrypted by the transaction key to the mobile terminal, and indicating the SD card installed in the mobile terminal to decrypt the received service data by the stored transaction key and update the service data stored in the SD card by using the decrypted service data.

26. The method of claim 10, further comprising:
determining, by the SD server, the identification number of the SIM corresponding to the serial number of the SD card required to update service data according to the pre-stored correspondence between the identification number of the SIM and the serial number of the SD card when the service data in the SD card is required to be updated;
transmitting, by the SD server, an encrypted transaction key and the determined identification number of the SIM to the mobile terminal with the SIM corresponding to the determined identification number of the SIM, and indicating the SD card installed in the mobile terminal to decrypt the encrypted transaction key and store the decrypted transaction key after determining that the received identification number of the SIM is the same as the identification number of the SIM installed in the mobile terminal; and
transmitting, by the SD server, service data encrypted by the transaction key to the mobile terminal, and indicating the SD card installed in the mobile terminal to decrypt the received service data by the stored transaction key and update the service data stored in the SD card by using the decrypted service data.
